(19) United States
(12) Patent Application Publication
(10) Pub. No.: US 2005/0123176 A1
(43) Pub. Date: Jun. 9, 2005

(54) Fingerprint reading device and personal verification system

(75) Inventors: Takayuki Ishii, Kanagawa (JP); Keisuke Ota, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/995,310

(22) Filed: Nov. 24, 2004

(30) Foreign Application Priority Data
Dec. 8, 2003 (JP) 2003-408992

(51) Int. Cl. G06K 9/00

(52) U.S. Cl. 382/124

(57) ABSTRACT

An influence by a light quantity distribution of light irradiating means in a fingerprint image is decreased, so that an excellent fingerprint image improved in contract can be obtained. Light irradiating means for irradiating a light on a finger arranged on a predetermined region, and a solid state image pickup element for receiving a diffused light from the inside of the finger by the light irradiated from this light irradiating means and for picking up the fingerprint image of the finger is provided, and the light irradiating means is arranged across a length at least equal to or more than an effective reading length (L) of the solid state image pickup element.

### BACKGROUND OF THE INVENTION

1. Field of the Invention

The present invention relates to a fingerprint reading device for picking up the fingerprint image of a finger by irradiating a light on the finger and a personal verification system including the same.

2. Description of the Related Art

In recent years, with the globalization of business activities such as electronic commerce and the like due to the remarkable advancement of information technology, the necessity of computerizing personal verification for the purpose of preventing an unauthorized use of information has been on the increase. As a technique of computerization of this personal verification, the method of inputting the image of a fingerprint has been in heavy usage, while, for example, a device using a total reflection prism as disclosed in Japanese Patent Application Laid-Open No. 2000-11142, which is a Japanese Patent, has been bristled with difficulties that its shape becomes large, and moreover, it is unable to discriminate a false fingerprint molded by resin and the like.

As the fingerprint reading device, which has improved such difficulties and is compact in size and high in reliability, there is a fingerprint reading device disclosed as follows. In Japanese Patent Application Laid-Open No. 2000-217803, which is a Japanese Patent, there is proposed a method in which a finger is allowed to contact the neighborhood of the surface of a solid state image pickup elements arranged two dimensionally, and the finger is irradiated with a near infrared ray, and a scattered light from the inside of the finger is received. In Japanese Patent Application Laid Open No. 10-289304, which is a Japanese Patent, there is disclosed a structure provided with light irradiating means composed of a LED and a light guide plate between the solid state image pickup elements arranged two dimensionally and the finger. However, in this system, the light from the LED cannot be effectively used.

The method disclosed in Japanese Patent Application Laid-Open No. 2000-217803, which is a Japanese Patent, will be described along FIG. 12.

In the fingerprint reading device shown in FIG. 12, on the surface of a solid state image pickup substrate 1, there are formed solid state image pickup elements 1a arranged two dimensionally at predetermined intervals p, upon which a cover glass 50 is adhered and fixed by a transparent sealing material 41. This solid state image pickup substrate 1 is fixed on a wiring substrate 3, and moreover, is electrically connected to a wiring 3a on the wiring substrate 3 by a wire 21. Further, a LED chip 10, which emits an infrared ray or a near infrared ray for lighting, is also fixed on the wiring substrate 3, and moreover, is connected to the wiring 3a on the wiring substrate 3 by the wire 12, and is protected by a sealing resin 11.

The light 10a radiated from this LED chip 10 is incident on a finger 20, and is diffused inside thereof, and is incident in the cover glass 50 through a fingerprint 20a of the finger 20 as a diffused light 10b. This incident light arrives at the solid state image pickup element 1a through the cover glass 50, and is photoelectrically converted here, thereby obtaining an electrical signal of a fingerprint image.

The cover glass 50 aims at protecting the solid state image pickup element 1a from being touched by the finger 20 so as not to be electrically mechanically broken, and at the same time, it is required to have an optical filter function for eliminating a disturbing light other than the fingerprint image. However, to obtain a sharp image, the thickness t of the cover glass 50 is required to be extremely thin, and to sidestep this requirement, it has been necessary to use an expensive material such as a fiber optics plate (FOP) and the like.

On the other hand, as a technology for realizing miniaturization at a low cost, a sweep type has been proposed in which positions of a finger tip and the solid state image pickup element are relatively moved, and continuous partial images of the moving finger tip are synthesized so as to obtain an image of the entire finger tip (for example, Japanese Patent Application Laid-Open Nos. 2002-216116, 2002-133402, H10-222641 and the like, which are Japanese Patents). In FIG. 2 of Japanese Patent Application Laid-Open No. H10-222641, although a structure being superposed up and down with a linear image pickup element, a linear light source having approximately the same width as the linear image pickup element, and an optical fiber is disclosed, this structure becomes large in a thickness direction so that it is difficult to make the entire device miniaturized. However, according to this technology, since the two dimensionally arranged solid state image pickup elements requiring an area having about a size of the finger tip so far can manage with the width only of the finger, the solid state image pickup elements, the fiber optics plate and the like becomes inexpensive. Further, the technology has an advantage of being able to realize miniaturization of the direction to which the finger tip is moved. In addition to the above described optical system, as for this sweep type, there have been known an electrostatic capacity system, a heat detector system, and the like.

In the finger tip reading device having a structure shown in FIG. 12, even in a state where the finger closely contacts the solid state image pickup element, light irradiating means (LED chip 10) does not closely contact the finger, and there exists a space between thereof. Hence, the light ray irradiated from the light irradiating means (LED chip 10) spreads in the space prior to entering the finger before the light ray irradiated from each LED chip 10 enters inside the finger, thereby decreasing variation of each intensity distribution. Moreover, since the light ray is diffused even inside the finger also, light quantity distribution is easy to improve in the vicinity of the solid state image pickup element 1a.

In the meantime, in an optical system sweep type fingerprint reading device, to realize miniaturization characteristic of the sweep type, the solid state image pickup element 1a and the light irradiating means (LED chip 10) are lined up in close vicinity, so that the entire shape of the fingerprint reading device is miniaturized. Moreover, this miniaturization is required not only for making the area of an inputting surface of the fingerprint reading device small, but also for the thickness of the entire fingerprint reading device. Hence, in a state where the finger and the solid state image pickup element closely contact, the light irradiating means is constituted at the same time in such a way as to be adjacent to the finger. Here, such a fingerprint reading device is referred to as an adjacent optical system sweep type fingerprint reading device. In this way, to realize the miniaturization, the adjacent optical system sweep type fingerprint reading device has the light irradiating means arranged adjacent to the solid state image pickup element, and moreover, it is in a state adjacent to the finger also.

However, in the fingerprint reading device using the above described conventional two dimensionally arranged solid state image pickup elements, the light irradiating means (LED chips 10) are arranged at a distance away from the solid state image pickup elements 1a, thereby an approximate uniform illumination is obtained by adding the light irradiated from each LED chip 10. However, in the fingerprint reading device realizing a miniaturization and a low cost such as the sweep type, since the light irradiating means are arranged adjacent to the solid state image pickup elements, a ratio of the direct attainment of the irradiating light from each LED chip 10 to the solid state image pickup element ends up increasing. Hence, the fingerprint image obtained in the fingerprint reading device ends up being strongly affected by the light quantity distribution of the irradiating light.

Here, the relation between an inputted fingerprint image and the light quantity distribution of the irradiating light in the adjacent optical system sweep type fingerprint reading device will be described.

In the adjacent optical system sweep type fingerprint reading device, the light quantity distribution by the light irradiating means arranged in a main scanning direction affects the fingerprint image in the main scanning direction of the solid state image pickup element 1a. As shown in FIG. 13, when looking at the fingerprint image of the main scanning direction by the output of the solid state image pickup element 1a, there is no distribution found in the light quantity of the light irradiating means, and moreover, when a signal ratio (contrast ratio) of the fingerprint ridge of the fingerprint image to the input signal of the fingerprint concave portion can be taken large, a sharp fingerprint image can be formed from the input signal from the fingerprint reading device.

Further, as shown in FIG. 14, when there is enough contrast available in the output of the solid state image pickup element, even in case there is the light quantity distribution available by the light irradiating means, an excellent fingerprint image can be inputted by an offset adjustment and a gain adjustment within a dynamic range of the solid state image pickup element.

In the meantime, as for an actual fingerprint, an individual difference of the finger tip state is large, and a fingerprint pattern itself is light, and there exist many test subjects who have a flat fingerprint having no difference of elevation in the fingerprint ridge portion and the fingerprint concave portion, and the fingerprint hard to generate the light quantity difference due to decrease in the difference of optical reflection coefficient of the fingerprint ridge portion and the fingerprint concave portion of a drying finger and the like. Therefore, as shown in FIG. 15, an optical contrast ratio toward the solid state image pickup elements ends up becoming small comparing to FIG. 13 and the like. Moreover, in the case of a thin film filter only as a protective layer 30, the entrance into the solid state image pickup element 1a of the irradiating light is increased, and therefore, there are often the cases where the shading difference due to the pattern of the fingerprint ends up becoming small.

In such a case, when the light quantity distribution by the light irradiating means changes in the main scanning direction of the solid state image pickup element, it turns into the output of the solid state image pickup element as shown in FIG. 15. As shown in FIG. 15, when there is little contrast in the input image, and moreover, when the changes of the light quantity are synthesized by the light irradiating means across the entire input signal, the contrast is improved from the input signal, so that a sharp fingerprint image is difficult to obtain.

Further, since the adjacent optical sweep type fingerprint reading device is a device for reading the entire fingerprint image of a finger tip by moving the finger tip against the solid state image pickup element, the partial fingerprint images of the imaged finger tip are fastened together, respectively, so that one piece of the fingerprint image of the entire finger tip is formed. To fasten together the partial fingerprint images, it is necessary that each partial image is sharp image information, and when deficiency is caused in the partial images, the entire image cannot be formed.

### SUMMARY OF THE INVENTION

The present invention has been made in order to solve the above described problems, and an object of the invention is to reduce the influence by the light quantity distribution of the light irradiating means in the fingerprint image and to obtain an excellent fingerprint image with in improved contrast.

The fingerprint reading device of the present invention comprises: light irradiating means for irradiating with a light a finger arranged in a predetermined region; and image pickup means for receiving the light emitted from the irradiation means and diffused inside the finger and for picking up a fingerprint image of the finger, and is a fingerprint reading device in which the light irradiating means and the imaging means are placed side by side, wherein the light irradiating means comprises a plurality of light sources formed along at least the main scanning direction of the image pickup region of the image pickup means, and is arranged along a length more than the reading effective length of the main scanning direction of the image pickup means.

Another aspect of the fingerprint reading device of the present invention reads the fingerprint image while relatively moving positions of the finger and the imaging means.

Further, the other aspect of the fingerprint reading device of the present invention is such that the light irradiating means emits at least either one from among the infrared light and the near infrared light.

Further, the other aspect of the fingerprint reading device of the present invention is such that variation in the light output of each light source is within 20% in the light irradiating means.

Further, the other aspect of the fingerprint reading device of the present invention is such that the plurality of light sources are installed at approximate equal intervals.

Further, the other aspect of the fingerprint reading device of the present invention is such that the light irradiating means is installed at the one side or both sides of the image pickup means in a direction to scan the finger for the image pickup means.

Further, the other aspect of the fingerprint reading device of the present invention comprises a solid state image pickup substrate in which a plurality of solid state image pickup elements constituting image pickup means are arranged, and a wiring substrate in which the solid state image pickup substrate and the light irradiating means are arranged.

Further, the other aspect of the fingerprint reading device of the present invention is such that a silicon substrate as a protection member is arranged on the surface to contact the finger tip in the solid state image pickup substrate.

Further, the other aspect of the fingerprint reading device of the present invention is such that the silicon substrate has thicknesses equal to or more than 30 μm or equal to less than 200 μm.

The personal verification system of the present invention includes the above described fingerprint reading device, fingerprint registering means for registering the fingerprint image of an object person to be individually verified in advance, fingerprint verifying means for verifying whether or not the fingerprint image read by the fingerprint reading device matches the fingerprint image registered in the fingerprint registering means and outputting the verification result as a personal verification signal.

According to the present invention, the light irradiating means constituted by a plurality of LEDs and the like is placed side by side with the imaging means, and the light irradiating means is arranged along the length more than the reading effective length in the main scanning direction along at least the main scanning direction of the image pickup region of the image pickup means, so that miniaturization of the entire fingerprint reading device and reduction of the influence by the light quantity distribution of the light irradiating means in the fingerprint image can be made compatible. In this way, a good quality fingerprint image improved in contrast can be obtained.

### BRIEF DESCRIPTION OF THE DRAWINGS

FIG. 1 is a schematic sectional view of a fingerprint reading device of a first embodiment of the present invention;

FIG. 2 is an oblique view of the fingerprint reading device of the first embodiment of the present invention;

FIG. 3 is a characteristic view showing a light intensity in a horizontal direction position in a solid state image pickup element;

FIG. 4 is a characteristic view showing the light intensity in case light irradiating means is spaced apart from about 2.5 mm from the solid state image pickup element in a sub scanning direction (vertical direction);

FIG. 5 is a characteristic view showing the light intensity in case a length of light irradiating means is set shorter than a reading effective length of the solid state image pickup element;

FIG. 6 is a characteristic view showing the light intensity in case the length of the light irradiating means is set longer than the reading effective length of the solid state image pickup element;

FIG. 7 is a schematic sectional view of the fingerprint reading device of a second embodiment of the present invention;

FIG. 8 is an oblique view of the fingerprint reading device of the second embodiment of the present invention;

FIG. 9 is a schematic block diagram of a personal verification system in a third embodiment of the present invention;

FIG. 10 is a schematic block diagram of the fingerprint reading device constituting the personal verification system in the third embodiment;

FIG. 11 is a view schematically showing the solid state image pickup element output of a fingerprint image in the fingerprint reading device of the present invention;

FIG. 12 is a view showing a conventional example, and a schematic block diagram of the fingerprint reading device;

FIG. 13 is a view schematically showing the solid state image pickup element output of the fingerprint image in the fingerprint reading device;

FIG. 14 is a view schematically showing the solid state image pickup output of the fingerprint image in the fingerprint reading device; and

FIG. 15 is a view schematically showing the solid state image pickup output of the fingerprint image in the fingerprint reading device.

### DESCRIPTION OF THE PREFERRED EMBODIMENTS

Embodiments of a fingerprint reading device and a personal verification system according to the present invention will be described below with reference to the drawings.

### First Embodiment

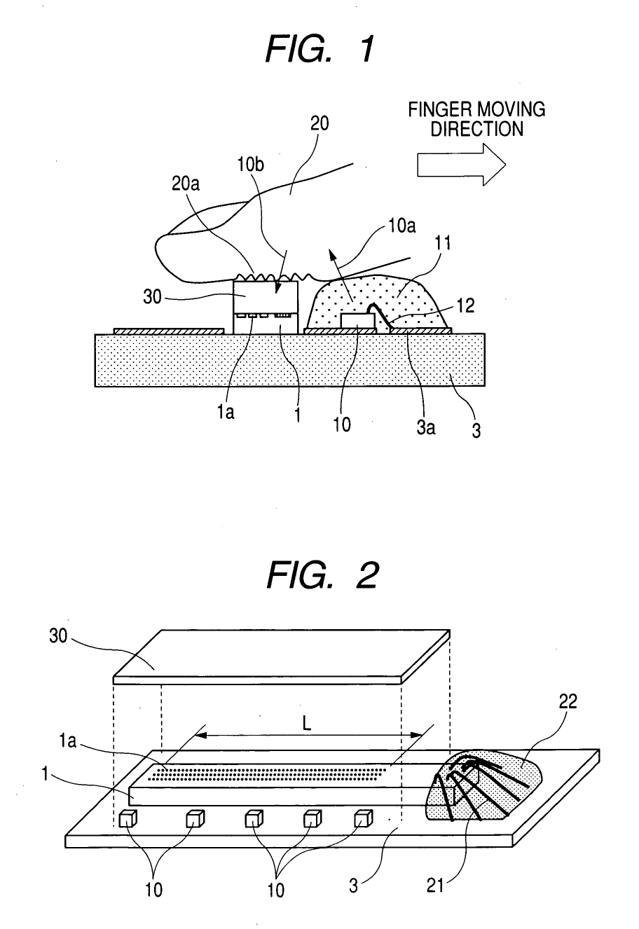

FIG. 1 is a schematic sectional view of the fingerprint reading device in a first embodiment of the present invention. Further, FIG. 2 is an oblique view of the fingerprint reading device in the first embodiment of the present invention.

In the fingerprint reading device shown in FIGS. 1 and 2, a solid state image pickup substrate 1 and a LED chip 10 are arranged on a wiring substrate 3. The solid state image pickup substrate 1 is mounted with a plurality of solid state image pickup elements 1a arranged in a line. A LED chip 10 has a LED which is light irradiating means for irradiating at least either one from among an infrared light and a near infrared light.

The solid state image pickup substrate 1, as shown in FIG. 2, has an electrode unit arranged at an end portion in a longitudinal direction electrically connected to a wiring 3a on a wiring substrate 3 by a wire 21. Similarly, the LED chip 10 has its electrode unit also electrically connected to the wiring 3a on the wiring substrate 3 by the wire 12. In the solid state image pickup substrate 1, a protective layer 30 is arranged on the reading surface to which a finger 20 contacts. As a material of the protective layer 30, glass, a SiO₂ thin film, a SiON thin film, a fiber optical plate and the like can be used. These materials are adhered on the solid state image pickup element 1a of the solid sate image pickup substrate 1 by a bonding agent which transmits the infrared light and the near infrared light.

The protective layer 30 is required to satisfy the following each item to be able to have a still lower price and to read a detailed image.
1. When considering the filtering out of the light (cross talk) into adjacent solid state image pickup elements, a refraction factor has to be high to suppress the spread of the light between incidence and emission.
2. An unnecessary light other than the irradiating light is not to be incident to obtain a sharp image.
3. To have abrasion-proof and weatherproof.
4. To be at a low cost.
5. To have easy workability.
6. When considering bowing and deformation, coefficient of linear expansion has to be close to the solid state image pickup substrate 1.

To satisfy the above requirements, a silicon substrate is particularly suitable. The silicon substrate is workable to attain a desired thickness by back grinding or back lapping. Further, since the silicon substrate transmits the infrared light and the near infrared light and cuts a visible light, it can cut an unnecessary light such as an external light. Since its refraction factor is also about 3.4, even when it has a thickness 1.5 to 2 times that of glass, it can obtain an equivalent resolution. In case the silicon substrate is used as the protective layer 30, the substrate having thicknesses from 30 μm to 200 μm is usable, and particularly, the thicknesses from 70 μm to 150 μm are suitable.

Further, as shown in FIG. 2, the solid sate imaging pickup element 1a has a reading effective length L in the main scanning direction (horizontal direction) formed in 15 mm. Further, a LED column which is the light irradiating means is constituted by five pieces of the LED chip 10, and the LED column is arranged in the range equal to or more than the reading effective length L of the solid state image pickup element.

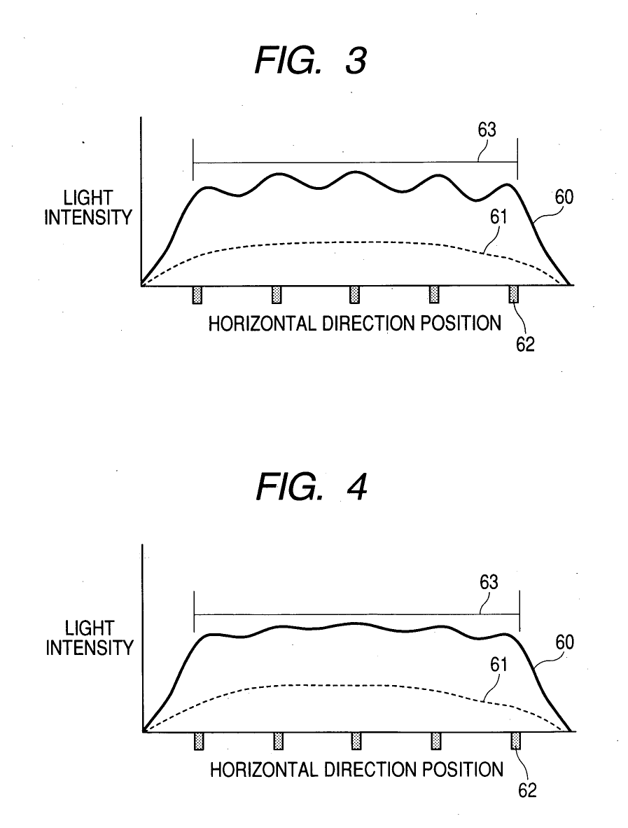

Here, in the fingerprint reading device of the present embodiment, the light quantity distribution by the light irradiating means at the main scanning direction (horizontal direction) in the solid state image pickup element 1a is studied. FIG. 3 is a characteristic view showing the light intensity in the horizontal direction position in the solid state image pickup element 1a. In FIG. 3, a solid line 60 denotes the light intensity in an adjacent state of the LED column, which is the light irradiating means, to the finger. Further, as a reference, the light intensity in case the light irradiating means is installed 1 mm spaced away from the finger is shown in a broken line 61. Further, the effective reading length of the solid state image pickup element 1a is a length shown in reference numeral 63. Granted that the solid state image pickup element 1a have in its outside most dummy pixels and the like which do not read an OB pixel and an image, those are naturally not taken into consideration as falling under the reading effective length. The installing position of the LED chip 10 used as the light irradiating means is shown in a square 62 under the graph.

The characteristic view shown in FIG. 3 shows the light intensity in case a sub scanning direction (vertical direction) distance with the solid state image pickup element 1a and the light irradiating means is about 1.5 mm. The characteristic shown by the solid line 60 is such that, since the finger is closely adhered to the light irradiating means, the light diffusion between the solid state image pickup element 1a and each light source 62 of the light irradiating means does not sufficiently proceed, so that the distribution of the light intensity in the solid state image pickup element 1a remains large. Further, by installing the light irradiating means isolated from a state of closely adhering to the finger, the change of the light intensity can be improved. However, that light intensity ends up being reduced to about one third as compared to the case where the light irradiating means is closely adhered to the finger.

In the meantime, FIG. 4 is a characteristic view showing the light intensity in case the light irradiating means is isolated about 2.5 mm from the sub scanning direction (vertical direction). In this case, even while the light irradiating means remains in a state of adhering to the finger, it will be appreciated that sufficiently uniformized light intensity can be obtained in the effective reading length 63 of the solid state image pickup element 1a.

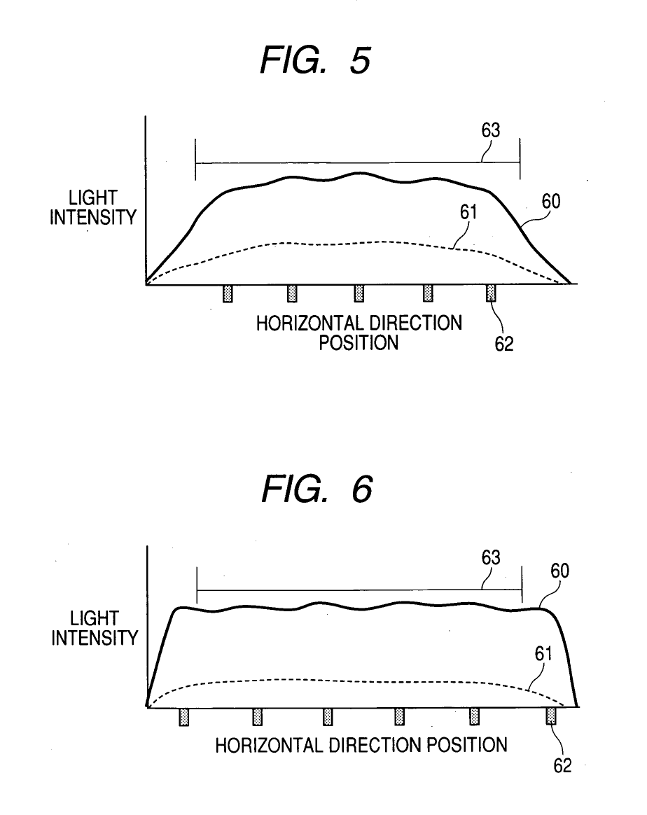

Further, FIG. 5 is a characteristic view showing the light intensity in case the range of the irradiating means is set shorter than the effective reading length 63 of the solid state image pickup element 1a. As evident from FIG. 5, the light intensity within the effective reading length 63 of the solid state image pickup element 1a is observed to be attenuated at both end portions of the effective reading length 63, so that uniformity of sufficient light intensity is not obtained. Further, FIG. 6 is a characteristic view showing the light intensity in case the light irradiating means is isolated about 2.5 mm from the solid state image pickup element 1a in the sub scanning direction (vertical direction) and the length in which the light irradiating means is arranged is set longer than the effective reading length 63 of the solid state image pickup element 1a. As evident from FIG. 6, in this case, uniformity of sufficient light intensity can be obtained within the effective reading length 63 of the solid state image pickup element 1a.

In the sweep type adjacent optical fingerprint reading device, in the case of the present embodiment, when the distance of the sub scanning direction (vertical direction) with the solid state image pickup element 1a and the LED column of the light irradiating means is, in consideration of the miniaturization, preferably set in the range of about 1.6 mm to 3.0 mm, and more preferably set in the range of about 2.0 mm to 2.5 mm, the influence of the solid state image pickup element 1a to the distribution of the light intensity in the LED light source can be decreased.

Although each LED chip 10 used in the LED column, which is the light irradiating means, is preferably all alike in its light output, in the actual LED chip 10, the light output has variation even in the same input current. Uniformity of the irradiating light in the present embodiment, when considering the influence toward a recognition rate of the fingerprint reading device generally required by its output image, is preferably about 20% as a light quantity distribution, and moreover, is required to be within 15% in case an accuracy is demanded. To maintain such uniformity of the irradiating light, variation of the light output of each LED chip 10 is also preferably within about 20%. Moreover, although the LED chips 10 are preferably lined up at equal intervals for the effective reading length L of the solid state image pickup element 1a, the intervals may be approximately the same.

Consequently, according to the present embodiment, by arranging the LED column in the LED chip 10 in the range equal to or more than the effective reading length L of the solid state image pickup element 1a, the influence by the light quantity distribution of the light irradiating means in the input fingerprint image of the fingerprint reading device can be decreased. Further, by using a silicon substrate as a thin film filter, an excellent fingerprint image improved in contrast and at a low cost can be obtained.

### Second Embodiment

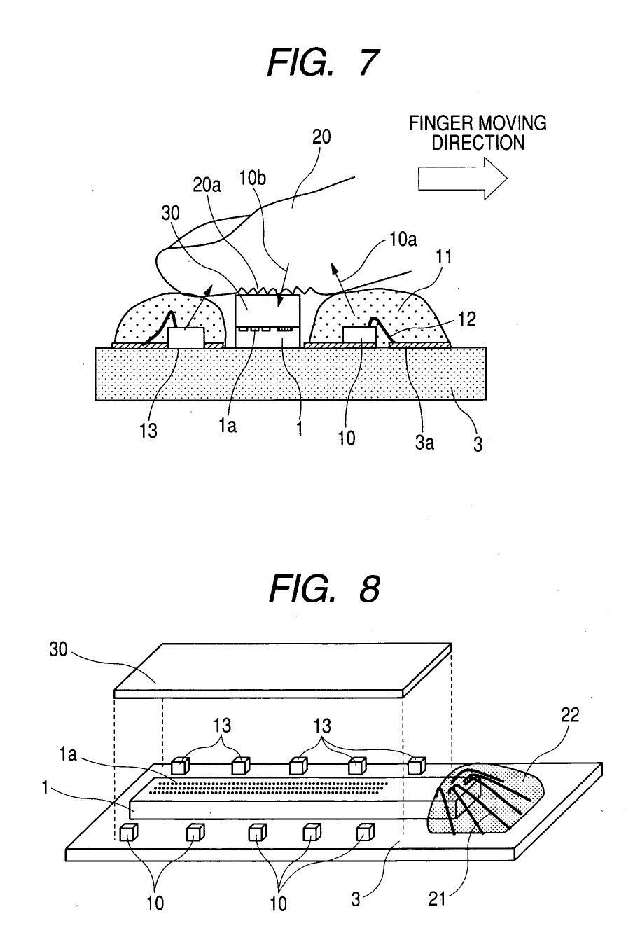

FIG. 7 is a schematic sectional view of a fingerprint reading device in a second embodiment of the present invention. Further, FIG. 8 is an oblique view of the fingerprint reading device in the second embodiment of the present invention.

While the fingerprint reading device in the second embodiment shown in FIGS. 7 and 8 has entirely the same constitution as the fingerprint reading device (see FIGS. 1 and 2) of the first embodiment, moreover, LED columns constituting light irradiating means are formed both up and down of a sub scanning direction (vertical direction) in a solid state image pickup element 1a. That is, the LED column of the present embodiment, as shown in FIG. 8, has a LED chip 10 arranged in a wiring substrate 3 similarly to the first embodiment and its electrode unit is formed by being electrically connected to a wiring portion of a wiring substrate 3 by a wire 12, and at the same time, a second LED column constituted by LED chips 13 is formed above for the sub scanning direction in the solid state image pickup element 1a. The LED chips 13 constituting this second LED column have the same number of LEDs as the first LED column, and are provided on the wiring substrate 3 at equal chip intervals.

Consequently, according to the present embodiment, in addition to the advantage in the first embodiment, the light quantity change in the sub scanning direction in the solid state image pickup element 1a can be further reduced.

In the sweep type fingerprint device, an image inputting of the entire finger is not performed, but a partial image of the finger to be scanned is taken, and from the characteristic point of each image, the fingerprint image has to be reconstituted. Hence, a continuity of the partial images to be used for image reconstitution is important. In practice, the light quantity change of the sub scanning direction of the solid state image pickup element 1a is important. In the partial images to be used for image reconstitution, the light quantity change of the sub scanning direction harms the continuity of the partial images obtained. Hence, in the fingerprint reading device of the second embodiment, since the continuity of the partial images of the fingerprint image inputted from the solid state image pickup element 1a is easily secured, a deficiency of partial images when reconstituting the entire fingerprint image does not develop, and moreover, accuracy of the obtained reconstituted image is high, so that a recognition rate in the fingerprint verification system using the fingerprint reading device of the present embodiment can be improved.

### Third Embodiment

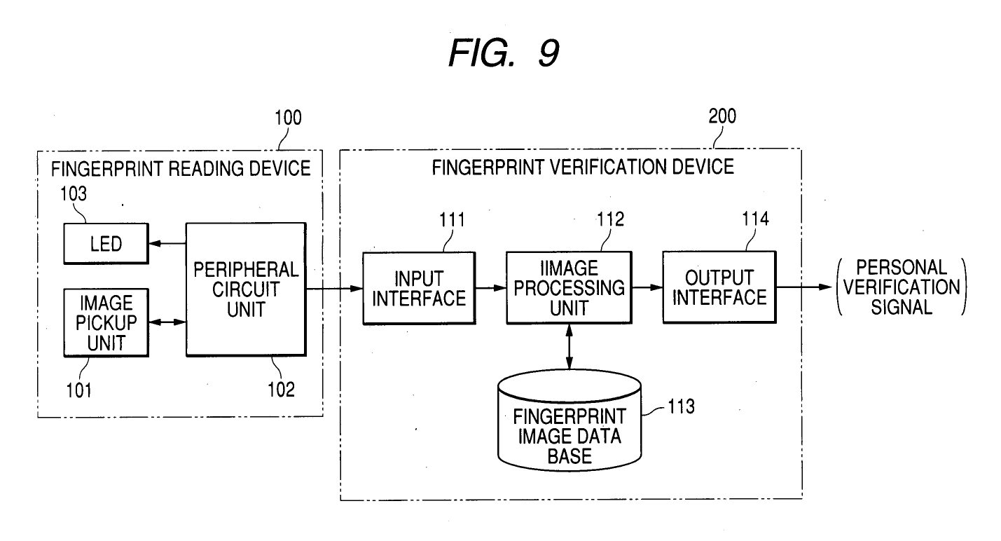

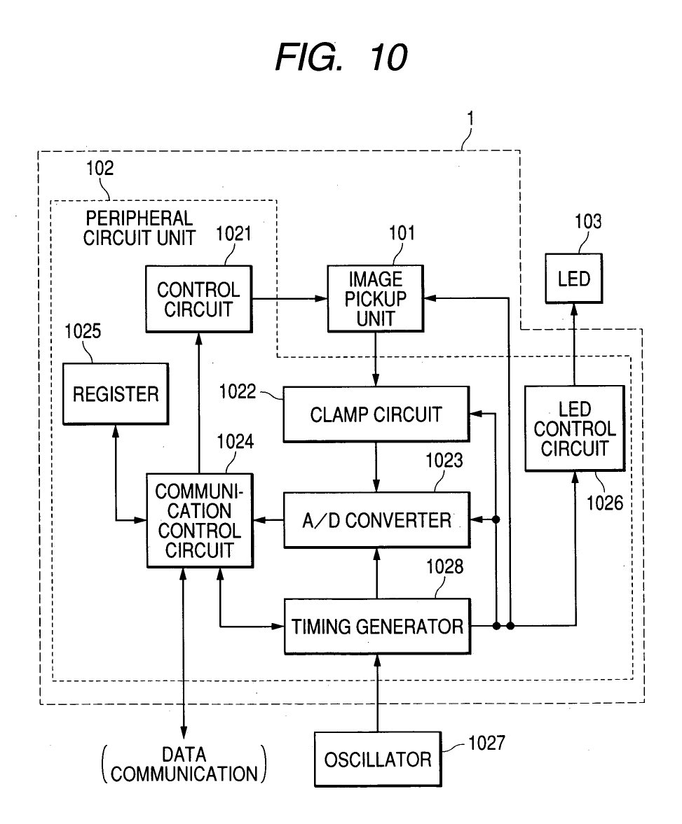

Next, an embodiment of a personal verification system including the above described fingerprint reading device will be described with reference to FIGS. 9 and 10.

FIG. 9 is a schematic block diagram of a personal verification system in a third embodiment of the present invention. Further, FIG. 10 is a schematic block diagram of a fingerprint reading device 100 constituting the personal verification system in the third embodiment.

The personal verification system shown in FIG. 9 comprises: the fingerprint reading device 100 comprising an image pickup unit 101 constituted by a solid state imaging senor 1a, a peripheral circuit unit 102 thereof, and a LED 103 mounted in a LED chip 10; and a fingerprint verification unit 200 which is connected to the fingerprint reading device 100 and performs a fingerprint verification.

The peripheral circuit unit 102, for example, is formed on a solid state image pickup element substrate 1, and as shown in FIG. 10, is constituted by including a control circuit (drive circuit) 1021 for controlling the operation of a solid state image pickup unit 101, an A/D converter 1023 for converting an analogue imaging signal corresponding to an image related to the finger pattern of a finger outputted from the image pick up unit 101 from an analogue signal to a digital signal through a clamp circuit 1022, a communication control circuit 1024 and a register 1025 connected to thereof for performing a data communication of the digital signal converted by the A/D converter 1023 as an image signal of the fingerprint for an external device (interface and the like), a LED control circuit 1026 for controlling the emission of the LED of the LED 103, and a timing generator 1028 for generating a control pulse for controlling the operation timing of the above described circuits 1021 to 1026 based on a reference pulse provided from an external oscillator 1027. The circuits including this peripheral circuit 102 are not limited to the above described circuits, but may include different types of circuits. Further, a portion of the above described circuits may be constituted as a different chip.

A fingerprint verification device 200 comprises: an input interface 111 for inputting a communication data outputted from the communication control unit 1024 of the peripheral circuit unit 102; an image processing unit (fingerprint verification means) 112 connected to this input interface 111; and a fingerprint image data base (fingerprint registration means) 113 connected to this image processing unit 112; and an output interface 114. The output interface 114 is connected to electronic equipment (including software also) required for the personal verification in order to ensure security and the like at the time of usage and login.

Here, a fingerprint image data base 113 is registered with a fingerprint image of the finger of an object individual to be individually certified in advance. The object individual here may be one or a plurality of individuals. The fingerprint image of the object individual is inputted from the fingerprint reading device 100 as the personal verification information of the object individual through the input interface 111 at an initial set-up time, an object individual adding time, and the like.

The image processing unit 112 inputs the fingerprint image read by the fingerprint reading device 100 through the input interface 111, and verifies whether or not the read fingerprint image matches the registered image of the fingerprint image data base 113 based on a known fingerprint verification image processing algorism, and outputs its verification result (fingerprint matches or does not match) as a personal verification signal through the output interface 114.

In the present embodiment, although the fingerprint reading device 100 and the fingerprint verification device 200 are constituted by separate devices, the present invention is not limited to this, but as occasion demands, at least a part of functions of the finger verification device 200 may be integrally constituted within the peripheral circuit 102 of the fingerprint reading device 100. Further, the personal verification system of the present embodiment may be integrally assembled and constituted within the electronic equipment required for the personal verification or may be constituted by a separate unit from the electronic equipment.

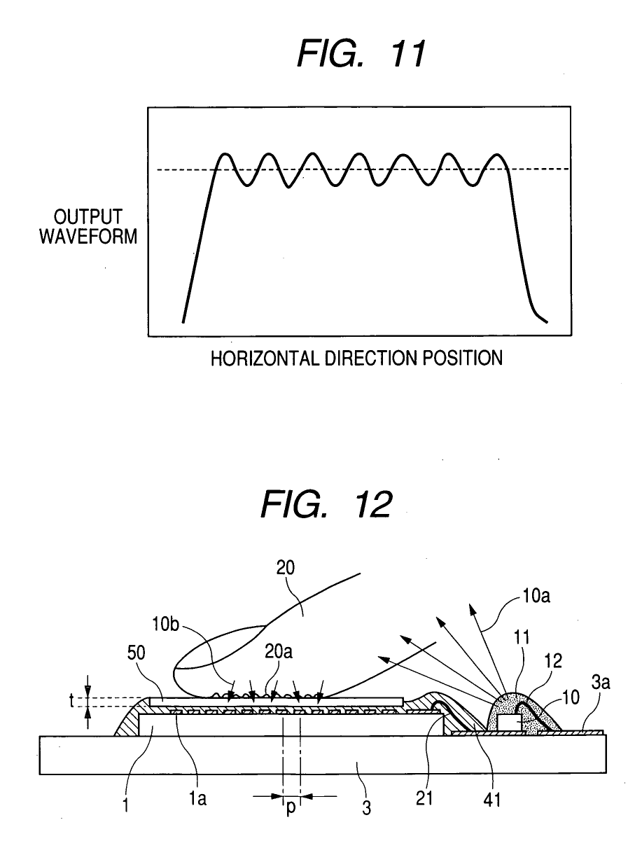

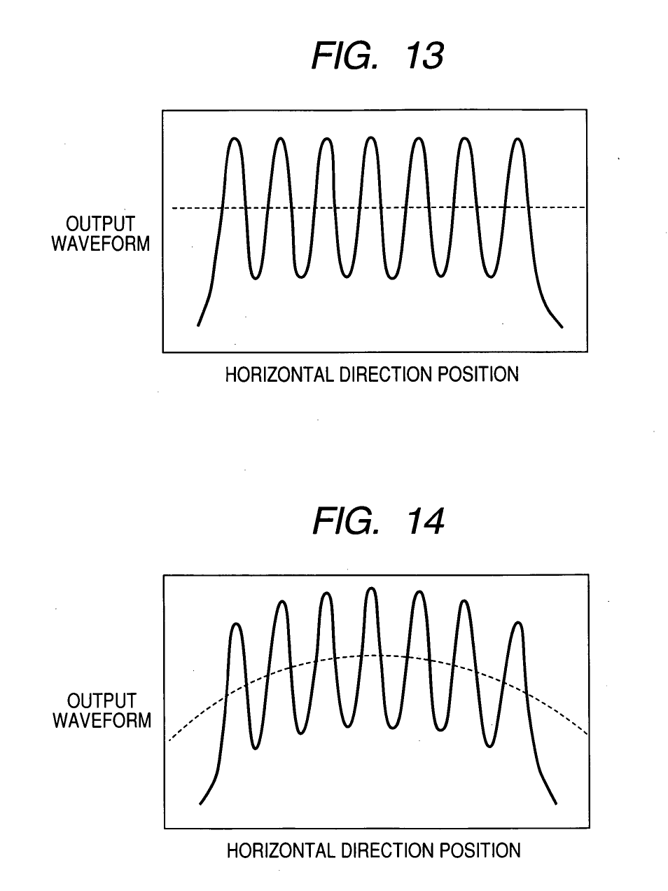

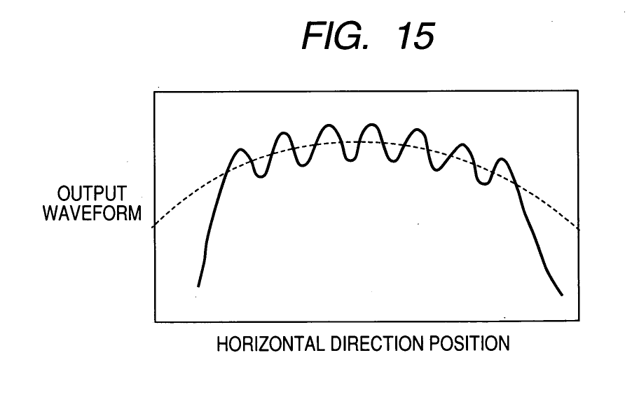

According to the present embodiment of the present invention, for the effective reading length of the solid state image pickup element 1a, the light irradiating means is arranged at the same position as both ends of the reading length or up to the outside position of that length, so that the irradiating light quantity distribution of the solid state image pickup element 1a can be easily improved, and an uniform light quantity by the light irradiating means can be obtained as shown in FIG. 11. Hence, the changed portion only of the output by the fingerprint pattern is enlarged from the output of the solid state image pickup element 1a, thereby improving the contrast and inputting an excellent fingerprint image.

This application claims priority from Japanese Patent Application No. 2003-408992 filed Dec. 8, 2003, which is hereby incorporated by reference herein.

1. A fingerprint reading device, comprising light irradiating means for irradiating with a light a finger arranged on a predetermined region, and image pickup means having a plurality of image pickup elements for receiving the light emitted from said irradiating means and a diffused inside the finger and picking up a fingerprint image of the finger, thereby reading said fingerprint image while relatively moving positions of the finger and said imaging means,
wherein said light irradiating means and said imaging means are placed side by side, and said light irradiating means comprises a plurality of light sources formed along at least the main scanning direction of an image pickup region of said image pickup means, and is arranged along a length equal to or longer than the effective reading length of the main scanning direction of said image pickup means.

2. The fingerprint reading device according to claim 1, wherein, for the effective reading length of the main scanning direction of said image pickup means, a distance in a sub scanning direction between said image pickup element and said light irradiating means is in the range of 11 to 20 percent.

3. The fingerprint reading device according to claim 1, wherein, said light irradiating means emits at least either one from among a infrared light and a near infrared light.

4. The fingerprint reading device according to claim 1, wherein a variation of a light output of said each light source in said light irradiating means is within 20%.

5. The fingerprint reading device according to claim 4, wherein said plurality of light sources are arranged at approximate equal intervals.

6. The fingerprint reading device according to claim 1, wherein said light irradiating means is provided at the one side or both sides of said image pickup means of a finger scanning direction for said imaging means.

7. The fingerprint reading device according to claim 1, further comprising a solid state image pickup element substrate in which a plurality of solid state image pickup elements constituting said image pickup means are arranged, and a wiring substrate in which said solid state image pickup element substrate and said light irradiating means are arranged.

8. The fingerprint reading device according to claim 7, wherein a silicon substrate is arranged as a protective member on a surface to which a finger tip contacts in said solid state image pickup substrate.

9. The fingerprint reading device according to claim 8, wherein said silicon substrate has thicknesses equal to or more than 30 μμm or equal to or less than 200 μm.

10. A personal verification system, including:
the fingerprint reading device according to claim 1;
fingerprint registration means for registering the fingerprint image of an object individual to be personally certified in advance; and
fingerprint verification means for verifying whether or not the fingerprint image read by said fingerprint reading device matches the fingerprint image registered in said fingerprint registration means and outputting a verification result as a personal verification signal.
